(19) United States
(12) Patent Application Publication
(10) Pub. No.: US 2016/0007576 A1
(43) Pub. Date: Jan. 14, 2016

(54) MODULAR OBSERVATION BEEHIVES AND METHODS OF USE THEREOF

(71) Applicant: Classroom Hives, Inc., Cambridge, MA (US)

(72) Inventors: Jeffrey W. Murray, Cambridge, MA (US); David T. Slaney, Cambridge, MA (US)

(73) Assignee: CLASSROOM HIVES, INC., Cambridge, MA (US)

(21) Appl. No.: 14/325,657

(22) Filed: Jul. 8, 2014

(51) Int. Cl. A01K 47/02

(52) U.S. Cl. CPC A01K 47/02

(57) ABSTRACT

The invention provides a modular observation bee hive system that can be easily assembled or dismantled without a significant risk of bees escaping, thus making the system uniquely suitable for providing a safe environment for observing the harbored bee colony. The invention also provides methods of using the same.

### COPYRIGHT AUTHORIZATION

A portion of the disclosure of this patent document contains material which is subject to U.S. copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

An observation hive with access to the outside allows people to witness, without interruption, almost all the activities of a colony of honeybees. It shows not just the individual bees but the whole population functioning together. Thus observation bee hives not only have entertainment value but also serve an education purpose, especially for museums and schools.

There are commercially available observation hives on the market, many are made for one size: 1 ½ frames, 3, 4, or larger. The smaller ones have definite limitations, as a colony can grow very quickly. These observation hive systems are typically designed for short term exhibition. See, for example, the single unit observation hive manufactured by The Walter T. Kelley Company (Clarkson, Ky.). The larger ones are often operated as the satellite of a regular Langstroth hive. They can last a long time, but are harder to manage, as they have to be moved to a safe location before they can be opened and maintained.

Thus there is a need to provide better designed observation hives that are suitable for long term exhibition, and are relatively easy to maintain and service, without compromising operational safety.

### SUMMARY OF THE INVENTION

One aspect of the inventions provides a modular observation bee hive system, comprising: (1) a gateway module; (2) one or more hive modules; and, (3) one or more sets of dividers; wherein the dividers are not part of an assembled observation bee hive comprising the gateway module and the one or more hive modules; and, wherein the dividers are inserted between the gateway module and one of the hive modules, or between two of the hive modules, to temporarily separate modules of the assembled observation bee hive when needed, e.g., for transportation or maintenance or to increase or decrease the size of the assembled observation bee hive.

In one embodiment, each set of dividers comprises two metal strips, each having sufficient length and width to separate the modules when inserted between the modules.

In one embodiment, the modular observation bee hive system according to any of the preceding embodiments, each said metal strips comprises flanges along the length of the strips.

In one embodiment, the modular observation bee hive system according to any of the preceding embodiments, each said flanges comprises a hole that aligns with a matching hole on the frame of the modules, such that a pin or a screw can be inserted to fasten the strip to the frame of the module.

In one embodiment, the modular observation bee hive system according to any of the preceding embodiments, the gateway module comprises an opening of about 0.75, 1, 1.25, 1.5, 2, or 2.5 inches diameter.

In one embodiment, the modular observation bee hive system according to any of the preceding embodiments, the total number of hive modules is 2, 3, 4, 5, 6, or 7.

In one embodiment, the modular observation bee hive system according to any of the preceding embodiments, the gateway module is situated at the bottom of the assembled observation bee hive.

In one embodiment, the modular observation bee hive system according to any of the preceding embodiments, the assembled observation bee hive has a capacity for about 5000, 6000, or 7000 honey bees.

In one embodiment, the modular observation bee hive system according to any of the preceding embodiments, each said hive modules has an internal dimension (e.g., space for bees to inhabit) of about 19-20 inches (horizontal length) by 9-10 inches (vertical height) by ¾ to 1.5 inches (width).

In one embodiment, the metal is steel, such as galvanized steel.

Another aspect of the inventions provides a method of separating two adjacent modules of an assembled observation bee hive, said assembled observation bee hive comprising a gateway module and one or more stacked and interconnected hive modules (such as a subject modular observation bee hive), the method comprising: (1) inserting a set of dividers between the two adjacent modules to cut off the connection between the two adjacent modules, wherein the dividers comprise two metal strips; and, (2) fastening one of said metal strips to one of said two adjacent modules, and fastening the other of said metal strips to the other of said two adjacent modules.

In one embodiment, each metal strip is fastened to the frame of said module, through pre-drilled and aligned holes on said metal strip and the frame of said module.

It is contemplated that all embodiments described herein, including those only in the example or the figures, can be combined with any other embodiments, unless explicitly disclaimed or not suitable.

### DETAILED DESCRIPTION OF THE INVENTION

### 1. Overview

The present invention relates to a modular observation hive system for easily assembling or dismantling a modular observation hive, without a significant risk of bees escaping, thus making the system uniquely suitable for providing a safe environment for observing the harbored bee colony. By using a system of metal or plastic “locks,” the assembled observation bee hive can be serviced on location, where it is unlikely that any bees will escape into the room hosting the hive. That is, the hive system does not need to be removed from its location for service. This not only saves time but also makes the exhibit safer. Another advantage of this type of hive system is that, because it is quite simple to take apart, and relatively small and light, it can be moved easily from one location to another, before the intact hive is reassembled (e.g., improved mobility to facilitate exhibition at different locations).

In particular, the system of the invention allows units or modules to be safely added or removed from an assembled observation bee hive with ease. The assembled observation bee hive comprises a gateway module having a passageway (e.g., a tube or a tube like chamber) connected to the outside, and allows the bees to come in and out of the hive. In certain embodiments, the gateway module may comprise an opening of about 1, 1.5, 2, 2.5, or 3 inches diameter at one end, such that bees can enter or exit the opening directly. Alternatively or in addition, a tube may be connected to the opening, such that the ultimate exist or entrance of the bee hive at the other end of the tube may be strategically placed. The length of the tube can be adjusted depending on specific need. For example, the tube may be 50, 75, 100, 150, 200, 250, 300 cm in length. The tube may be metal or plastic, may be transparent, translucent, or opaque, and may be flexible or rigid.

In certain embodiments, the other side end of the gateway module (opposite to the entry-exit) also contains an opening. This opening can usually be close r covered, but the cover can be removed to insert a vacuum hose to quickly such away dead bees falling to the bottom of the hive. It has been helpful in quickly reducing the amount of dead bees at the bottom of the hive in times of sickness, and has in one occasion saved a hive from destruction. Although the entry/exit port can be used for the same purpose, in cases where the entry/exit port is permanently or semi-permanently secured to a tube for outside connection, it is beneficial to have the 2^{nd} port on the opposite side of the gateway module.

In certain embodiments, the gateway module is situated at the bottom of the assembled observation bee hive. In certain embodiments, the gateway module is situated at the top of the assembled observation bee hive.

The assembled observation bee hive also comprises several (e.g., 2, 3, 4, 5, 6, or 7, preferably 5 or 6) hive modules to accommodate different colony sizes. Each hive module is essentially a box enclosing a deep Langstroth frame, with the correct bee space around it, so that bees can freely circulate behind 2 pieces of transparent observation panels (such as ⅛″ glass panes) that form the long sides of the box. The hive modules are designed to be stacked one on top of another, with free passage way between two connecting modules.

In certain embodiments, the passageway between the two connected hive modules are free of other obstructions, e.g., the opening at one end of a hive module is directly coupled to the opening at one end of another connecting hive module, such that bees can move from one module to another or build structures (e.g., honey combs) that traverse the two connoted hive modules without obstruction. In certain embodiments, the connection or opening between the two adjacent modules (internal space between the two observation panels) is at least 0.75, 1, 1.25, 1.5, or 1.75 inches wide.

In certain embodiments, both open sides of each hive module are equivalent, e.g., the hive module can be used upside down to facilitate easy manufacturing.

In certain embodiments, one open end of the hive module receives a top cover that may optionally comprise one or more openings suitable for accommodating feeding cups, e.g., feeding cups for holding honey or sugar solution to feed the colony.

In certain embodiments, the assembled observation bee hive has a total capacity for about 5000, 6000, or 7000 honey bees.

The observation bee hive system also comprises one or more sets of dividers (preferably made in metal) for physically separating the modules of the assembled observation bee hive. The dividers are not part of the assembled observation bee hive, and are not required for day-to-day operation of the hive. Each set of dividers can be inserted between the gateway module and one of the hive modules, or between two of the hive modules, to temporarily separate modules of the assembled observation bee hive when needed (e.g., for transportation or maintenance or to increase or decrease the size of the assembled observation bee hive). More than two sets of dividers can be used simultaneously if more than one separations need to be made at the same time, e.g., when more than one modules of the assembled hive need to be taken apart together.

In certain embodiments, each set of dividers comprises two metal strips, each having sufficient length and width to separate the modules when inserted between the modules. When the modules are separated, no bees can travel between the separated modules, and no bees can escape any of the separated modules.

In certain embodiments, each said metal strips comprises flanges along the length of the strips. In certain embodiments, each said flanges comprises a hole that aligns with a matching hole on the frame of the modules, such that a pin or a screw can be inserted to fasten the strip to the frame of the module. The flanges are useful to properly align the dividers along the length of the module, in order to minimize the risk that any mis-alignment would result in a gap for any bees to escape. The optional pre-drilled holes not only further facilitates alignment of the dividers with the modules, but also provide a means to fasten the divider to the separated module securely such that the separated modules, with bees inside, can be safely transported individually with minimal risk of escaping bees.

In certain embodiments, the assembled observation bee hive further comprises one or more supporting frames for strengthening the overall structural integrity of the assembled observation bee hive. For example, when the assembled observation bee hive comprises 5 or 6 hive modules and a gateway module, stacked vertically one on top of another, the overall height of the assembled observation bee hive can be well over 3 meters. Thus the stability and integrity of the assembled hives can be improved by including a wood frame that supports one or both sides of the vertically stacked hive modules.

In certain embodiments, the assembled observation bee hive further comprises an external temperature regulating component to regulate hive temperature (see below), which may be important to ensure long term survival of the bee colony through winter.

For example, the external temperature regulating component may include a thermometer, such as one that can measure the surface temperature of an observation panel on one or more hive module. In certain embodiments, the external temperature regulating component comprise an insulation layer, such as a foam rubber insulation layer, that can be fitted on the observation panel to maintain hive temperature. To snuggly fit the observation panel, the insulation layer may be cut an ⅛ of an inch wider in width and height, for fitting tightly over the otherwise exposed (glass) observation panel. In certain embodiments, the external temperature regulating component comprise a cooling device, such as a fan that can be aimed towards the part of the assembled observation bee hive in need of cooling.

In certain embodiments, the assembled observation bee hive supports continuous habitation by a bee colony for at least 1 year, 2 years, 3 years, 4 years, 5 years, 6 years, 10 years, 15 years or more.

Another aspect of the invention provides a method of separating two adjacent modules of an assembled observation bee hive, such as a subject observation bee hive described herein above, said assembled observation bee hive comprising a gateway module and one or more stacked and interconnected hive modules, the method comprising: (1) inserting a set of dividers between the two adjacent modules to cut off the connection between the two adjacent modules, wherein the dividers comprise two metal strips; and, (2) fastening one of said metal strips to one of said two adjacent modules, and fastening the other of said metal strips to the other of said two adjacent modules.

In certain embodiments, each metal strip is fastened to the frame of said module, through pre-drilled and aligned holes on said metal strip and the frame of said module.

In certain embodiments, any module, including modules in between two modules, is separated from the two adjacent modules using 2 pairs of dividers, without first removing the module on the top or bottom of the module to be removed.

With the invention generally described above, certain aspects of the invention and detailed description of the various embodiments are provided further below.

### 2. The Modular Observation Hive System

The modular observation hive system is modular. Thus in the fall, when the bee population diminishes, it can be reduced to two or three one-frame or one-hive module. In the spring, when the bee colony augments dramatically, three or four more hive modules can be added. Typically, no more than six hive modules are used in a hive, but larger colonies can be accommodated with more hive modules.

The modular observation hive system of the invention can be made based on the description above, or can be made based on a modification of existing commercial models, such as components made by The Walter T. Kelley Co. (Clarkson, Ky.).

The assembled observation hive is simply a hive whose individual frames or hive modules are each contained in a box with glass sides so that all the activities within are visible to an observer. Certain commercial products on the market such as the single unit observation hive manufactured by the Walter T. Kelley Co. can readily be adapted to construct the hive module of the present invention. If an observation hive manufactured by the Walter T. Kelley Co. is used, it is recommended to follow Kelley's instructions with the extra precaution of checking the grooves cut in the wooden components for the glass before starting, to make sure that they will accommodate ⅛″ glass (actually about 7/64″). If they are too narrow, then they should be widened with a table saw so the glass will fit, being careful to cut a bit off the outside part of the groove, otherwise cutting on the inside would interfere with the internal dimension or bee space. Titebond or Guerilla glue can be added to each joint that is nailed together for additional strength.

Briefly, the Kelley product offers first, a base with an attached bottom board, which encloses the deep Langstroth frame between 2 panes of glass. They are designed to allow a bee space between the comb in the frame and the glass on each side. In the base, the frame is raised up approx. 2″ above the bottom board so that, at one end it has a 1¼″ O.D. (outside diameter) hole to accommodate a 1″ I.D. (inside diameter) clear Teflon tube that can lead to the outside. In the subject modular system, however, a separate gateway module is used for entry and exit.

Specifically, the gateway module has essentially the same dimension as that of a hive module, expect that its vertical height is significantly less since it is designed not for housing bees but as a dedicated modular unit for entry and exit. Thus the height of this unit may be just enough to allow an opening or hole at one end as an entry/exit port, or a port for receiving a tube. Thus in one (side) end of the gateway module is a 1¼″ hole (preferably centered, and preferably 1⅜″ above grade). This can be plugged with a removable piece of matching (e.g., 1¼″) dowel/stopper so that a 1″ O.D. Teflon tube, attached to a vacuum cleaner can be inserted, if necessary, to clean out dead bees that may have accumulated at the bottom of the gateway module (if the gateway module is at the bottom of the assembled observation bee hive. Once the stopper is pulled out and the small 3×3″ piece of plastic has been introduced, the structure can be covered with another small piece of plastic or wood that has a 1″ O.D. hole in it. Then a 1″ O.D. vacuum tube may be put against it, before taking out the first piece of plastic and then introducing the vacuum tube.

The cover of the base “super” unit from the Kelley product can be removed so that it becomes a hive module with both top and bottom openings, so that multiple hive modules can be stacked.

Once a desired number of hive modules are connected to the gateway module (preferably one located at the bottom), the top hive module can be covered by a top cover with the optional holes for holding one or more feeding cups. The entire system can be further strengthened by adding one or more side support bars or beams to secure all vertically stacked modules.

The assembled observation bee hive can be fixed at a permanent location, or be taken down from such a location using the dividers of the invention for easy transport to a different location.

Once a permanent location is chosen, depending on the location of the sun (preferably east, south, or southeast facing), the tube (if any) connected to the gateway module can be placed in advance in the hole on the side of the gateway module through a wall (of a building) of somewhat larger outside diameter, or through a similar hole in a board placed under a window sash (e.g., foam rubber, or some kind of blocking can be used to make sure the bees, on their orientation flights, for example, do not come through the opening of the separated sashes). That way the bees can come in and out of the tube without ever coming into or through the room. Other windows in the room should always have adequate screening to prevent accidental entry.

When the hive is moved to a location, the tube should already be in place or reattached. A stopper may be used to block the hole at the base of the observation hive, e.g., the hole on the side of the gateway module when needed (e.g., when transporting).

To avoid any bees getting out during the transition, one can use a small piece of clear plastic 3/32″ thick, (say 3×3″) to temporarily cover the opening. One can remove the stopper until it is just ⅛″ of an inch away from the surface of base directly in front of the hole; slip the plastic over the hole between the stopper and the hive; and remove the stopper. While holding the plastic firmly over the hole, one can move the hive to where the Tube is located. Watching through the clear plastic, one can line up the tube with the entrance hole, remove the plastic and introduce the tube, all while being careful not to have it stick out beyond the inside surface of the hive. Marking the tube beforehand with a marker just the right depth to push it in can help to do it safely. It should not go beyond an ⅛^{th} inch away from the interior surface and also as it goes through the wall of the house or a board, beyond the outside surface.

Also be careful not to inadvertently pull the tube out from the other end where it is inserted in the hole.

In certain embodiments, it may be advantageous to make the tube as long as possible (e.g., up to 2 feet). It allows one to see the bees going out, and those bees laden with nectar, water, and pollen coming in. But it should not be left uncovered because the tube may be pulled out of the opening. A transparent, rigid, plastic cover should preferably go over it.

The top cover optionally has one or two holes, such as 2¾″ holes, that allow introducing feeder jars (water and syrup). As mentioned earlier, the Kelley system “supers” with glass on each side come without a cover, and have the same interior spacing so that when they are attached to the base, they form additional space for the hive, in the same proportions.

In the present invention, the Kelly observation hive can be further modified by attaching the “supers” or the single observation module with four 1⅝″ drywall screws, 2 on each side, for connecting with a supporting frame. Preferably, a small washer is used. It is recommended to pre-drill the bottom rails of the supers with a drill bit that is slightly wider than the drywall screw diameter, this allows first the base and then the top super to be pulled into the table on which it sits, or the unit underneath. It also makes it a lot easier to disengage them. The four holes can be drilled randomly, but far enough apart so that they are still able to hold the upper frame to the lower one securely. Otherwise, since the “supers” are interchangeable, after a while, the bottom holes would be stripped out if they were continually set on top of one another.

The Kelley system cover, with the 2¾″ holes, has a ⅜″ thick protruding section that is designed to set into the bee space below it. The bottom protrusion needs to be removed (on a table saw for example), because when the 3/32″ plastic, or metal piece is slipped in to remove it from the super below, that protrusion, when lifted, opens a space from which bees can escape.

The cover should preferably be attached with 4 screws, such as 1¼″ drywall screws rather than 1⅝″, because it is much narrower.

In certain embodiments, the opening(s) on the top cover is screened (e.g., by using any metal or plastic screening materials of suitable sizes). Some screening can be stapled to the bottom of the cover, which can be either covered again (except for the 2¾″ holes) with a 3/32″ thick veneer or plastic, or with some 3/32″ plastic strips on the indented wood. The plastic, or metal, lock can slip between it and the bottom container easily.

Once the screen is in, moving and refilling the jars is quick and easy, but one needs to make sure that the lids are touching the screen below so that the liquids get transferred to the screen by surface tension. Otherwise, the bees will not receive them. One way of doing this is to fold up some screening material into a small square that comes in contact with both the lid and the screen, or, at worse, use anything that will absorb a liquid, e.g., cloth, paper towels etc. To help this process, the holes in the lids should be punched from the inside out. In the summer, one or both of the 2¾″ holes can be uncovered for better ventilation as they form a kind of channel for circulating air that passes through the entrance tube to the top of the hive. By the same token, even if no liquids are being fed in the winter, they should be covered to keep the hive warm and not let in ambient (cold) temperature air in.

There are at least two considerations when feeding the hive with syrup:

1. If the solution is too diluted, after a while it develops a black mold, which eventually will lead to rejection by the bees.

2. If the solution is too concentrated, it crystallizes at the bottom of the jar and seals the liquid in, again making it unavailable to the bees.

Thus one exemplary formula is 1 part white sugar to 1 part water by volume, or a little more (e.g., 2 parts sugar to 1 part water) when there is a need for comb building. Preferably, brown sugar is not used as the impurities in it make it hard for the bees to digest.

When preparing the syrup, one should ensure absolute cleanness of the containers. After washing the containers, boiling for ten minutes or rinsing them out with denatured alcohol is recommended. This prevents the syrup from being contaminated with mold or other microorganisms. As an added precaution, once the syrup is ready, it can be decanted into another clean jar and brought to a slight boil in a Microwave oven. This also serves the purpose of avoiding the crystallization.

The observation panes are preferably made by glass. The ⅛″ glass is the most satisfactory for an observation hive, since it is strong, can be disengaged from the hive modules, and is easily cleaned. In contrast, 3/32″ glass is liable to frequent cracking. In addition, ⅛″ plastic, which is not easily broken, can also be used. It is quite flexible, but can sometimes be pushed into the bee space to disturb the bees. Further, after awhile it tends to be clouded by UV light, such as that in the sunlight.

The dividers of the invention can be used to add or remove any module (such as hive module) from the assembled observation bee hive.

When using a pair of metal divider, the best form of locks are metal sheets, such as stainless steel, galvanized steel, or aluminum. Each divider of the pair of dividers can be made based on the dimension of the modules. For example, the dividers may be 4¼″ wide×23″ long, optionally with raised ¾″ flange (along the length). One of the ends can also be raised flange, but this is not necessary. Starting from the same end, holes (e.g., ⅛″ holes) can be drilled at a predetermined interval, such as one each at 4″, 10″, 16″ and 20″ from one end of the divider, preferably in the middle of the raised edges/flange, preferably on each side (⅜″ up from the edge).

For modules with about 20 inch length, one can push a piece of ridged wire through the 2 holes at the 20″ mark; and place a module up against the wire. Mark off where the other holes correspond on the module. Pre drill holes based on the markings, for inserting screws (e.g., ¾″ screws) through the holes and tightening them so that they enter approximately ½″ to ⅝″ into the bottom of the module. When drilling, do not to go so far as touching the glass, which might break. Repeat the same procedure for the top rail of the module, making sure that the top of the lower module below it, and the bottom of the upper module above it are always covered. To perform this operation:

1. Take out the four 1⅝″ drywall screws that hold 2 supers together.

2. Then slip the first metal piece in with the sides facing down. The end pushed in should be beveled with a file top and bottom. Sometimes it may be necessary to lift up the module very slightly to allow the “lock” to slip by. Sometimes the metal encounters burr comb but it will cut right through it, even if some resistance may be encountered. The 3¾″ screws can then be screwed on each side.

3. Push the second piece of metal with the sides facing up, and screw the ¾″ screws in the appropriate holes. As long as the module is covered, it can be lifted off from the bottom one. Steel pieces have been introduced to the top of the module underneath and to the bottom of the module to be removed.

When using a pair of plastic divider, described below is a method using 3/32″ thick plastic.

1. Take out the four (1⅝″) drywall screws that hold two adjacent modules together.

2. Slip the first ( 3/32″) piece of plastic (4″ wide and not less than 23″ long) between the modules to be separated. It should be beveled with a file at both ends as in the case of the metal pieces. Again sometimes it may be necessary to lift up the module very slightly to allow the “lock” to slip by. Also, again, sometimes the plastic encounters burr comb but it will cut right through it, even if some resistance may be encountered.

3. Pick up the second piece of plastic ( 3/32″ thick, at least 23″ long, and this time 4⅝″ wide, or slightly wider). Attach three pieces of duct tape, about 20″ long with equal lengths protruding from each side, on the underside of the plastic, firmly pressed on. This is important because if the tape is loose, it will curl up as the two plastic pieces are slipping on each other. They should be attached evenly, one close to each end, and one in the middle.

Each piece of evenly spaced duct tape hangs down about 8″ on each side of the bottom frame. Once the second piece of plastic is directly under the module, the 6 hanging ends (3 on each side) are brought up and adhered to the glass above it.

It is then possible to carefully slip off the upper module from the bottom one.

By these methods, especially the metal divider embodiment, it is possible to break the hive down to its component parts and make it unlikely that a single bee will get in the room.

Very occasionally there is so much filled comb between the two hive modules that the plastic pieces can be stuck together by the honey that has dripped from the comb. In this situation, 2 people should be present while working the hive. One can hold down the bottom piece of plastic and the other can remove the module above, making sure that the plastic piece on the bottom of it stays in place. Otherwise it is possible to inadvertently lift the cover from the module below and let out some of the bees. In exceptional circumstances, when, for example the hive is very populated, or if it is needed to take the removed module on a longer trip, then four 20″ strips of duct tape may be used instead of three. With the metal locks, it is not necessary to give any extra support.

As mentioned above, the observation hive should ideally be attached securely to a table or platform to avoid possible accidents. These, in turn, should ideally be attached to the floor, or the wall, or they must be made heavy enough so they cannot be easily moved.

The Kelley observation hive, especially if it is more than 1 frame high, should preferably be stabilized. As more and more modules are added to the hive vertically, the hive can easily tip over, even if the base is screwed into the table, so it needs to be attached to a frame at its highest point.

To do so, the base should ideally be screwed into the table or a platform below it. If there are more than two 1 frame modules, a 1×4 (¾″×3½″) 5′ long board can be attached to the back of each one of the modules (e.g., the opposite end of where the tube comes out and above the clean out port) with 1 (1⅝″ drywall) screw about 6″ up from the bottom of the base, and 4″ from the bottom of each additional super. This is because the hive can potentially end up with a gateway module and 5-6 hive modules.

Take a piece of ¾″ plywood 24″×48″ cut it in 3 pieces 10″×24″ approximately, and one piece about 18″ wide. Place the 2 long lengths of 2×4 side by side so they are 24″ apart, from outside edge to outside edge. Place the 2, 24″, 2×4 at each end, and nail them into the ends of the long lengths of 2×4. Take the 18″ wide piece of plywood and attach it to the bottom of the structure. Take the remaining 3, 10″ wide pieces of ¾″ plywood and place one at the height of the table, one approximately where the highest super will be located, and one at the very top where the second 2×4 cross piece joins the 2 vertical 2×4s. Before screwing them on, apply either glue (Titebond or Guerilla glue) to the plywood.

Attach the 4 plywood pieces to the 2×4s. With six or eight 1⅝″ drywall screws, 3 to each side touching the 2×4 (sides, and/or top and bottom). Lift this structure, with the plywood facing the hive. Attach it to the floor, to the platform or table and above through the plywood to the 1×4.

When attaching to the floor, it helps to first attach another piece of 2×4×24″ directly under the stabilizer to the floor with screws then use 2, ½″×2½″ lag screws to fasten it to this piece. It makes it easier to take it on and off when servicing the hive.

Stabilizer attached to a 2×4 screwed into the floor. Note the two ½″×2½″ Lag screws that hold the stabilizer to the 2×4.

There are different ways to introducing bees into the assembled hive: capturing a swarm; buying 1 lb. of bees and a queen; etc. Preferably, one should get an already developed frame of brood, and add a queen bee to the hive.

This is a relatively simple operation: get a healthy brood frame from a beekeeper, and place it in the hive module directly above the gateway module, or a hive module directly above that hive module. Obtain a queen bee and put her within her queen cage in the third hive module above, and let the bees do the rest. The “hygienic” queens are an alternative to adding chemicals to protect against problems like Varroa or various viruses. Preferably, no chemicals are added to the hives of the present invention.

One of the intervention that makes it possible to maintain observation hives long term, especially over long cold winter or hot summer, is helping the bees manage thermoregulation. The European Honey Bee (Apis Mellifera) evolved ways to maintain temperature within the hive at about 35° C. (95° F.) within extremes of cold and heat.

In cold weather, because each module is isolated as a single module, these small colonies do not benefit from the survival strategies of a normal hive: an accumulated population, interspersed in ten frames in the form of a spherical cluster that generates plenty of heat. Therefore in the winter, the bees should be insulated. Since the hive is always open to the outside, cold air comes in regularly. If there are no bees on a particular module in the hive, that module can be left without insulation, and it acts as a heat exchanger between the warm room and the cold air coming in. It is possible that some of the insulation is also useful in keeping the hive from getting too warm from the heated room inside.

Often a small flattened cluster is formed which, when the glass is covered on both sides with insulation, is able to keep itself warm by only exposing the very edge of it's circumference to the cold.

2″ thick rubber foam insulation can be applied to the glass surface, cut ⅛″ wider on 2 sides so that it will fit snugly into that space and be held there by the slight compression of the frame. Foam rubber companies have the tools to do this easily, but otherwise a sharp knife and careful measurement will do.

In warm weather, after it has dispersed its population, the Observation hive is deprived of another temperature regulating strategy: having a multi frame brood area containing many cells they can fill with drops of water to cool by evaporation. To compensate a fan, directed at the brood frame will keep the hive from overheating, by cooling the surface of the glass directly in front of it.

Measuring temperature is then very important when managing observation hives. It requires a bit of ingenuity as the center of the brood chamber moves around and it is not always possible to get an exact reading. Just placing a hand on the glass over the bees in the brood chamber is a quick way to check the hive. If it feels warm, it's a good sign. It means the correct brood temperature has been reached.

In cold weather if there are no hot spots, on the other hand it's a bad sign. It usually means that the hive is not getting enough food, because normally most of the heat comes from what is generated from digestion of honey or sugar syrup. In warm weather, if the temperature goes above 38° C. (100° F.) then the hive needs to be cooled by a fan.

There are some devices that can be placed directly in a frame and that will measure temperature quite accurately. Unfortunately they only work when the sensor is in the middle of the brood frame. However, the brood nest often will move on beyond the sensor.

Others that can be applied to the glass on the outside are not as accurate; they tend to read at a much lower temperature than exists in the actual space, (30.5° C. (87° F.) instead of 35° C. (95° F.)). In both cases it is possible to learn how to read them in relation to their particular location.

The hive can be moved using a process that is the reverse of the installation mentioned above. The hive should be kept upright as much as possible when traveling. It may be kept in place using the insulations as cushions against say a heavy toolbox, or with bungee cords.

It should be moved at least six miles away from its original location to avoid having the foragers return to their original sites. If this is not possible, not all the population will be lost probably (at the most a third) because the house bees may not have been oriented to the old location.

What is claimed is:

1. A modular observation bee hive system, comprising:
(1) a gateway module;
(2) one or more hive modules; and,
(3) one or more sets of dividers;
wherein said dividers are not part of an assembled observation bee hive comprising said gateway module and said one or more hive modules; and,
wherein said dividers are inserted between said gateway module and one of said hive modules, or between two of said hive modules, to temporarily separate modules of the assembled observation bee hive when needed (e.g., for transportation or maintenance or to increase or decrease the size of the assembled observation bee hive).

2. The modular observation bee hive system of claim 1, wherein each set of dividers comprises two metal strips, each having sufficient length and width to separate said modules when inserted between the modules.

3. The modular observation bee hive system of claim 2, wherein each said metal strips comprises flanges along the length of the strips.

4. The modular observation bee hive system of claim 3, wherein each said flanges comprises a hole that aligns with a matching hole on the frame of the modules, such that a pin or a screw can be inserted to fasten the strip to the frame of the module.

5. The modular observation bee hive system of claim 1, wherein the gateway module comprises an opening of about 2.5 inches diameter.

6. The modular observation bee hive system of claim 1, wherein the total number of hive modules is 5 or 6.

7. The modular observation bee hive system of claim 1, wherein the gateway module is situated at the bottom of the assembled observation bee hive.

8. The modular observation bee hive system of claim 1, wherein the assembled observation bee hive has a capacity for about 5000, 6000, or 7000 honey bees.

9. The modular observation bee hive system of claim 1, wherein each said hive modules has an internal dimension of 19-20 inches (horizontal length) by 9-10 inches (vertical height) by ¾ to 1.5 inches (width).

10. A method of separating two adjacent modules of an assembled observation bee hive, said assembled observation bee hive comprising a gateway module and one or more stacked and interconnected hive modules, the method comprising:
(1) inserting a set of dividers between the two adjacent modules to cut off the connection between the two adjacent modules, wherein the dividers comprise two metal strips; and,
(2) fastening one of said metal strips to one of said two adjacent modules, and fastening the other of said metal strips to the other of said two adjacent modules.

11. The method of claim 10, wherein each metal strip is fastened to the frame of said module, through pre-drilled and aligned holes on said metal strip and the frame of said module.
